(19) United States
(12) Patent Application Publication
(10) Pub. No.: US 2006/0055177 A1
(43) Pub. Date: Mar. 16, 2006

(54) Control device for a module forming a lock mechanism

(76) Inventor: Johann Robert, Ernemont sur Buchy (FR)

Correspondence Address: Liniak Berenato;Longacre & White, Suite 240, 6550 Rock Spring Drive, Bethesda, MD, 20817, US

(21) Appl. No.: 10/523,768

(22) PCT Filed: Aug. 6, 2003
(86) PCT No.: PCT/EP03/50364

§ 371 Date: Feb. 8, 2005

(30) Foreign Application Priority Data
Aug. 9, 2002 (FR) 0210150

(51) Int. Cl. E05C 3/06

(52) U.S. Cl. 292/201

(57) ABSTRACT

The present invention is directed to a control device for a locking mecahsnism including a Bowden-type cable containing a cable (14) provided with a proximal (14P) and a distal extremities, which are arranged in a jacket (18) having a proximal (18P) and a distal extremities which are blocked by a proximal (20P) and a distal arresting units. At least one of the extremities (18P, 18D) of the jacket (18) is connected to the corresponding arresting unit (20P, 20D) by gluing. In a preferred embodiment, a glued resting unit (20D) is provided with a part (22) in the form of a connecting sleeve for the glued extremity (18P) of the jacket (18). A part (22) is provided with an orifice (28) which is arranged transversally with respect to the direction of the connecting sleeve of the glued extremity (18P) of the jacket (18), thereby forming a receptacle for the glue mass.

The present invention relates to a control device for a module forming a lock mechanism.

The prior art already discloses a control device for a module forming a lock mechanism, of the type comprising a Bowden-type cable containing a cable having two ends, a proximal end and a distal end respectively, this cable being housed in a jacket having two ends, a proximal end and a distal end respectively, which are immobilized by two proximal and distal retaining elements.

This type of control device is used particularly for controlling a lock for the opening leaf of a motor vehicle, particularly for the side door of the vehicle.

The proximal end of the cable is connected to a control lever, also known as a paddle handle, pivot-mounted on the opening leaf so that it can be actuated from the inside of the vehicle. The distal end of the cable is connected to a control element for the module forming the lock mechanism. This module, provided with a latch, is arranged on the opening leaf so that, when the opening leaf is in the closed position, the latch engages with a striker borne by a corresponding frame.

When fitting the control device, it is particularly advisable to adjust the length of the proximal end of the cable protruding outside the jacket, through the proximal end of the latter, so as to allow for take-up of various functional play in the lock module and the control device. This adjustment makes it possible to achieve a desired travel for the control lever.

After carrying out the adjustment above, the proximal end of the jacket is immobilized with respect to the proximal retaining element. It is known practice to fasten the proximal end of the jacket to the proximal retaining element by an ultrasonic welding process.

However, the jacket is generally formed by a wire, particularly a metal wire, wound into a spiral with contiguous turns. This structure of the jacket does not always make it possible to obtain a quality ultrasonic weld providing the jacket with good pull-out resistance. In fact, the ultrasonic waves in some cases cause deformation of the spiral forming the jacket of the cable.

The object of the invention is to immobilize the end of a jacket on a corresponding retaining element with the aid of fastening means which provide effective resistance to pull-out and are well suited to a spiral structure of the jacket.

To this end, the subject of the invention is a control device for a module forming a lock mechanism, of the aforementioned type, characterized in that at least one of the ends of the jacket is connected to the corresponding retaining element by adhesive bonding.

Adhesive bonding makes it possible to overcome undesirable effects linked with ultrasonic waves, such as the deformation of the spirally wound wire forming the jacket of the cable. Adhesive bonding thus makes it possible to fasten the jacket to a retaining element in an efficient and resistant manner.

According to other optional characteristics of this control device:
the bonded retaining element is provided with a part forming a sleeve for fitting the bonded end of the jacket, the sleeve-forming part containing an orifice which is substantially transverse to the direction in which the bonded end of the jacket is fitted, this orifice forming a receptacle for holding a mass of adhesive in contact with the jacket and the bonded retaining element;
the sleeve-forming part of the bonded retaining element is extended by a shell provided with means for securing it to a fixed support;
the bonded end of the jacket is its proximal end;
the proximal end of the cable is provided with a block for securing this cable, the shell forming a housing for this securing block;
the jacket is formed by at least one wire, particularly a metal wire, wound into a spiral with contiguous turns;
the module forming a control mechanism is arranged in an opening leaf of a motor vehicle, particularly a side door of the vehicle.

A better understanding of the invention will be gained from reading the description below, which is given purely by way of example and with reference to the drawings, in which:

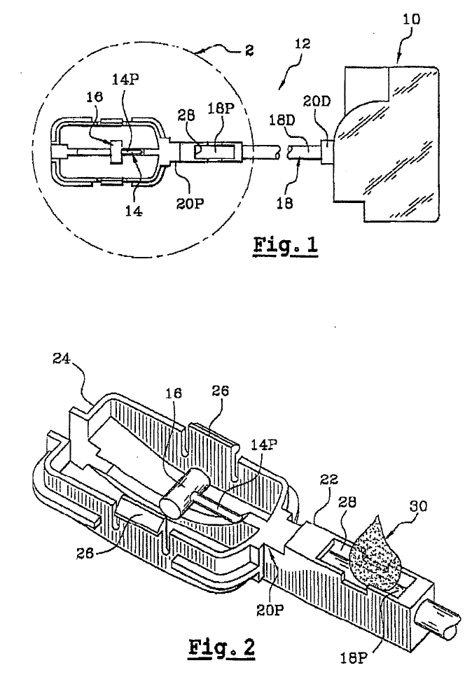

FIG. 1 is a general view of a module forming a lock mechanism, provided with a control device according to the invention;

FIG. 2 is a detail view of the circled part 2 of FIG. 1.

FIG. 1 represents a module 10 forming a lock mechanism controlled by means of a device 12 according to the invention.

In the example described, the module 10 is arranged in an opening leaf of a motor vehicle, more specifically a side door of this vehicle.

The control device 12 is intended to connect a control element for the module 10 with a conventional control lever (not shown), also known as a paddle handle, pivot-mounted on the opening leaf so that it can be actuated from the inside of the vehicle.

In the text hereinbelow, with consideration to the kinematic linkage between the control lever and the module 10, on the one hand the term “proximal” will be used to qualify a component close to the control lever and remote from the module 10 and, on the other hand, the term “distal” will be used to qualify a component remote from the control lever and close to the module 10.

The control device 12 comprises a Bowden-type cable which, in the conventional way, contains a cable proper which is slidably mounted in a jacket.

Thus, this Bowden cable contains a cable 14 having two ends, a proximal end and a distal end respectively. The figures show only the proximal end 14P of the cable. As is conventional, the proximal end 14P of the cable is provided with a block 16 for securing this cable to an element linked kinematically to the control lever. This block 16 is usually made of a metal alloy commonly designated by the name “Zamak”.

The cable 14 is housed in a jacket 18 having two ends, a proximal end 18P and a distal end 18D respectively. The jacket 18 is formed by at least one wire, preferably a metal wire, wound into a spiral with contiguous turns.

The distal end 18D of the jacket is immobilized by fastening in a manner known per se in a distal retaining element 20D borne by the module 10.

The proximal end 18P of the jacket is immobilized by fastening in a proximal retaining element 20P, which is represented in more detail in FIG. 2.

According to the invention, at least one of the ends 18P, 18D of the jacket, namely the proximal end 18P in the example described, is connected by adhesive bonding to the corresponding retaining element, namely the proximal retaining element 20P in the example described.

The (bonded) proximal retaining element 20P is provided with a part 22 forming a sleeve for fitting the (bonded) proximal end 18P of the jacket. This part 22 is extended by a shell 24 provided with conventional means for securing it to a fixed support (not shown) attached to the opening leaf. These securing means comprise two snap-locking tabs 26, for example.

It will be noted that the shell 24 forms a housing for the securing block 16.

The sleeve-forming part 22 contains an orifice 28 which is substantially transverse to the direction in which the proximal end 18P of the jacket is fitted. This relatively large orifice 28 forms a receptacle for holding a mass of adhesive 30 in contact with the proximal end 18P of the jacket and the proximal retaining element 20P.

Fastening the proximal end 18P of the jacket to the proximal retaining element 20P can therefore be achieved very simply.

First of all, the length of the proximal end 14P of the cable protruding outside the jacket 18, through the proximal end 18P thereof, is adjusted in a manner known per se so as to take up various functional play in the module 10 and in the control device 12.

The proximal end 18P of the jacket is then fastened to the proximal retaining element 20P by filling the orifice 28 with a mass of adhesive 30. The latter, in contact particularly with the proximal end 18P of the jacket and with the edges of the proximal retaining element 20P delimiting the orifice 28, adheres strongly to the jacket 18 and the proximal retaining element 20P so as to provide a strong fastening which does not deform the spiral structure of the jacket 18.

Advantageously, a notch may be made on the proximal end 18P of the jacket in order to optimize the attachment of the mass of adhesive.

It will be noted that the proximal end 18P of the jacket, fitted in the sleeve-forming part 22, constitutes a base of the receptacle for holding the mass of adhesive 30. Moreover, it is not necessary to close off the orifice 28 after the mass of adhesive 30 has been placed therein.

If required, the edges of the proximal retaining element 20P delimiting the orifice 28 may comprise projecting or recessed reliefs which optimize the adherence of the mass of adhesive 30.

1. A control device for a module (10) forming a lock mechanism, of the type comprising a Bowden-type cable containing a cable (14) having two ends, a proximal end (14P) and a distal end respectively, this cable being housed in a jacket (18) having two ends, a proximal end (18P) and a distal end (18D) respectively, which are immobilized by two proximal (20P) and distal (20D) retaining elements, characterized in that at least one of the ends (18P, 18D) of the jacket (18) is connected to the corresponding retaining element (20P, 20D) by adhesive bonding, the bonded retaining element (20P) being provided with a part (22) forming a sleeve for fitting the bonded end (18P) of the jacket (18), the sleeve-forming part (22) containing an orifice (28) which is substantially transverse to the direction in which the bonded end (18P) of the jacket (18) is fitted, this orifice (28) forming a receptacle for holding a mass (30) of adhesive in contact with the jacket (18) and the bonded retaining element (20P).

2. The device as claimed in claim 1, characterized in that the bonded end (18P) of the jacket (18) is its proximal end.

3. The device as claimed in claim 2, characterized in that the proximal end (18P) of the jacket (18) is provided with a notch for optimizing the attachment of the mass of adhesive (30).

4. The device as claimed in claim 1, characterized in that the edges of the orifice (28) are provided with projecting or recessed reliefs for optimizing the attachment of the mass of adhesive (30).

5. The device as claimed in claim 1, characterized in that the sleeve-forming part (22) of the bonded retaining element (20P) is extended by a shell (24) provided with means (26) for securing it to a fixed support.

6. The device as claimed in claim 5, characterized in that the proximal end (14P) of the cable (14) is provided with a block (16) for securing this cable (14), the shell (24) forming a housing for this securing block (16).

7. The device as claimed in in claim 1, characterized in that the jacket (18) is formed by at least one wire, particularly a metal wire, wound into a spiral with contiguous turns.

8. The device as claimed in claim 1, characterized in that the module (10) forming a control mechanism is arranged in an opening leaf of a motor vehicle, particularly a side door of the vehicle.

9. A method of adjusting a Bowden-type cable containing a cable (14) having two ends, a proximal end (14P) and a distal end respectively, this cable being housed in a jacket (18) having two ends, a proximal end (18P) and a distal end (18D) respectively, this jacket being intended to be immobilized by two proximal (20P) and distal (20D) retaining elements, characterized in that:
the length of the proximal end (14P) of the cable protruding outside the jacket (18) through the proximal end (18P) of the latter is adjusted, then
the proximal end (18P) of the jacket is fastened to the proximal retaining element (20P) by adhesive bonding.
